(19) United States
(12) Patent Application Publication
(10) Pub. No.: US 2011/0228268 A1
(43) Pub. Date: Sep. 22, 2011

(54) Method Of Analyzing A Composition Containing Impurities

(76) Inventors: John Hadd, Saginaw, MI (US); Ron Holmes, Midland, MI (US); Carl Puehl, Midland, MI (US)

(21) Appl. No.: 13/129,454

(22) PCT Filed: Nov. 16, 2009
(86) PCT No.: PCT/US09/64533

§ 371 Date: May 16, 2011

Related U.S. Application Data
(60) Provisional application No. 61/115,451, filed on Nov. 17, 2008.

(51) Int. Cl. G01J 3/28; G01N 1/22

(52) U.S. Cl. 356/311; 73/863.11

(57) ABSTRACT

A method of analyzing a composition and a method of processing the composition are provided. The composition contains impurities and has a boiling point less than ambient temperature and/or a vapor pressure greater than water at 14.5 ° C. The method of analyzing the composition comprises a step of providing the composition in a liquid state within a vessel. The composition is chilled in the liquid state within the vessel at a temperature below the boiling point of the composition, thereby maintaining the composition in the liquid state. The chilled composition in the vessel is converted to produce at least one of a vaporized composition and a nebulized composition, which converted composition is introduced into an analytical device. A measurement of content of the impurities of the composition is obtained from the analytical device. The method of processing the composition includes the same steps as the method of analyzing the composition, and but further requires that at least a portion of the composition remains in the supply tank.

### CROSS-REFERENCE TO RELATED APPLICATIONS

This application claims priority to and all the advantages of U.S. Provisional Pat. App. No. 61/115,451, filed on Nov. 17, 2008.

### BACKGROUND OF THE INVENTION

1. Field of the Invention

The instant invention generally relates to a method of analyzing a composition containing impurities. More specifically, the instant invention relates to a method of analyzing a composition having a boiling point less than ambient temperature and/or a vapor pressure greater than water at 14.5° C. in a way that enables measurement of content of the impurities within a minimal period of time and with maximum accuracy compared to existing methods of analyzing such compositions.

2. Description of the Prior Art

In many industries, including the semiconductor, geological and environmental industries, there is a need to analyze compositions containing impurities for the purpose of measuring the content of the impurities. In the semiconductor industry, in particular, content of impurities in precursor compositions that are used to make crystalline silicon and, ultimately, semiconductor wafers dictates quality and performance of the semiconductor wafers produced from the precursor compositions. As such, analysis of content of the impurities of the precursor compositions is necessary to determine whether or not a precursor composition satisfies the standards set for a given semiconductor wafer application, and failure to perform such analysis may result in quality control problems and substandard performance of the semiconductor wafers.

Methods of analyzing compositions containing impurities for the purpose of measuring the content of the impurities of the compositions are known in the art. For example, graphite furnace atomic absorption (GFAAS), glow discharge mass spectroscopy (GD-MS), and inductively coupled plasma (ICP) spectroscopy, such as ICP mass spectroscopy (MS), ICP optical emission spectroscopy (OES), or ICP atomic emission spectroscopy (AES) are known techniques for measuring elemental content of compositions. The ICP techniques utilize an argon ion plasma to evaporate, dissociate, and excite atoms or ions. In the plasma, analyte species are quantified either by detecting and measuring the level of light emitted by the excited atoms or ions compared to the level of emission from a calibration standard (ICP-AES/OES), or alternatively are separated by mass and compared to the mass of a calibration standard (ICP-MS). In the semiconductor industry, and with silicon-based semiconductors in particular, the precursor compositions typically include, as the primary ingredient, chlorosilanes, i.e., mono-, di-, tri-, and/or tetra-chlorosilanes. The precursor compositions have a boiling point less than ambient temperature and/or vapor pressures which can range from about 25 kPa at 14.5° C. to about 150 kPa at 14.5° C. Typical methods of analyzing chlorosilane compositions containing impurities for the purpose of measuring the content of the impurities of the chlorosilane compositions include evaporating off the chlorosilanes, thereby leaving a residue consisting of solid impurities that were present in the chlorosilane compositions. The chlorosilanes are evaporated and, thus, removed from the composition to be tested due to the fact that the chlorosilanes form solid byproducts of hydrolysis and cause spectral interference during analysis through the ICP techniques and further due to the fact that the high vapor pressure of the chlorosilanes will affect measurements obtained through the ICP techniques, in most cases actually extinguishing the plasma. The residue that remains after evaporating the chlorosilanes is then dissolved in acidic solution and diluted volumetrically to produce a liquid phase sample. The liquid phase sample is then nebulized and introduced into the plasma that is generated in accordance with the ICP-MS, ICP-OES, and ICP-AES techniques set forth above.

There are many disadvantages associated with the existing techniques described above. In particular, the techniques described above generally fail to adequately measure content of volatile impurities that are lost with evaporation of the chlorosilanes. Further, the techniques described above generally require days to return analytical results, which reduces processing efficiency and requires excessive foresight to prevent manufacturing delays.

In view of the foregoing, there remains an opportunity to provide a method of analyzing a composition having a boiling point less than ambient temperature and/or high vapor pressure in a way that enables measurement of the content of the impurities of the composition within a minimal period of time and with maximum accuracy compared to existing methods of analyzing such compositions.

### SUMMARY OF THE INVENTION AND ADVANTAGES

The instant invention provides a method of analyzing a composition and a method of processing the composition. The composition contains impurities and has a boiling point less than ambient temperature and/or a vapor pressure greater than water at 14.5° C. The method of analyzing the composition comprises a step of providing the composition in a liquid state within a vessel. The composition is chilled in the liquid state within the vessel at a temperature below the boiling point of the composition, thereby maintaining the composition in the liquid state. The chilled composition in the vessel is converted into at least one of a vaporized composition and a nebulized composition, which converted composition is introduced into an analytical device. A measurement of content of the impurities of the composition is obtained from the analytical device. The method of processing the composition includes the same steps as the method of analyzing the composition, but further requires that at least a portion of the composition remains in the supply tank.

In another embodiment of the method of analyzing the composition, the composition comprises chlorosilane and has a boiling point of less than about 58° C. and a vapor pressure of from 25 kPa at 14.5° C. to 150 kPa at 14.5° C. The composition is provided in the liquid state within the vessel. The composition is then introduced into a gas chromatograph. Chlorosilane is separated from the composition in the gas chromatograph to produce a chlorosilane portion and a residual portion. The residual portion is introduced into the analytical device, and a measurement of content of the impurities in the residual portion is obtained from the analytical device.

Due to the fact that the composition is maintained in the liquid state until converted into the vaporized composition and/or the nebulized composition, or alternatively due to the fact that the composition including chlorosilane is introduced into the gas chromatograph, many steps are eliminated that were previously required for analysis techniques that relied on evaporation to obtain a residue, which residue is subjected to analysis. The elimination of such steps, in accordance with the method of the instant invention, enables the measurement of content of the impurities of the composition within a minimal period of time. Further, the method of the instant invention enables the measurement of content of the impurities of the composition with maximum accuracy compared to existing methods of analyzing such compositions. The maximized accuracy is due to the fact that volatile impurities, which are lost during the evaporation step of existing analysis techniques, remain in the vaporized composition and/or nebulized composition that is introduced into the analytical device, or remain in the residual portion from the gas chromatograph, and are therefore available for measurement. Further, by chilling the composition and converting the chilled composition into the vaporized composition and/or nebulized composition in a controlled manner, or by separating the chlorosilane portion from the composition in the gas chromatograph, rapid evaporation due to high vapor pressure of the composition (especially when the composition includes chlorosilane) is avoided, thereby ensuring that operation of the analytical device remains unhindered and further ensuring that the plasma is not extinguished by quick evaporation of the composition.

### DETAILED DESCRIPTION OF THE INVENTION

The instant invention comprises a method of analyzing a composition and a method of processing the composition. More specifically, the method of analyzing the composition is intended for compositions that contain impurities and that have a boiling point of less than ambient temperature and/or a vapor pressure greater than water at 14.5° C., and the method is performed for purposes of determining content of the impurities of the composition. For many applications, content of the impurities of the composition is indicative of quality of the composition and, ultimately, quality of products made from the composition. For example, the composition analyzed in accordance with the instant invention may be processed to form semiconductors. As known in the art, even low content of impurities of compositions that are processed to form semiconductors may result in substandard or out-of-specification semiconductors produced from the compositions, and even minor differences in measurements of content of the impurities of the composition and actual content of impurities may result in out-of-specification semiconductors. As described in additional detail below, the method of the analyzing of the instant invention provides measurements of content of the impurities that are more closely indicative of actual content of the impurities of the compositions analyzed than existing methods, especially for the compositions that have a boiling point of less than ambient temperature and/or a vapor pressure greater than water at 14.5° C.

As alluded to above, the composition analyzed in accordance with the instant invention has a boiling point less than ambient temperature and/or a vapor pressure greater than water at 14.5° C. For example, in one embodiment, the composition has a boiling point less than ambient temperature, but does not have a vapor pressure greater than water at 14.5° C. In another embodiment, the composition has a vapor pressure greater than water at 14.5 ° C., but does not have a boiling point less than ambient temperature. In yet another embodiment, the composition has both a boiling point less than ambient temperature and a vapor pressure greater than water at 14.5° C. In the respective embodiments, at least some of the reactants and/or components present in the composition analyzed have a boiling point that is less than ambient temperature and/or a vapor pressure greater than water at 14.5° C. such that the composition, as a whole, has a boiling point that is below ambient temperature and/or a vapor pressure greater than water at 14.5° C. The suitability of the method of the instant invention for analyzing compositions having a boiling point below ambient temperature and/or a vapor pressure greater than water at 14.5° C. is not to be read as limiting the method of the instant invention, but is rather a characterization of the type of compositions for which the method of the instant invention provides significant benefits. Stated differently, while the method of the instant invention provides significant benefits to analysis of compositions having a boiling point less than ambient temperature and/or a vapor pressure greater than water at 14.5° C., the method of the instant invention may also be utilized to analyze compositions having a boiling point above ambient temperature and/or a vapor pressure less than or equal to water at 14.5° C.

By the phrase “ambient temperature” as used herein, it is meant a temperature of an atmosphere surrounding the composition analyzed. As such, it is to be appreciated that the “ambient temperature” may vary depending upon the particular circumstances under which the composition is analyzed. For example, while “ambient temperature” is typically normal room temperature of about 21° C., the ambient temperature may be higher under certain circumstances, such as in factory settings where temperatures are known to exceed normal room temperature. Regardless of the actual ambient temperature, the method of the instant invention is intended for implementation under conditions in which the composition analyzed would normally experience boiling (e.g., conditions of low pressure), which is undesirable for purposes of the method of the instant invention. In terms of actual temperatures, the ambient temperature in accordance with the instant invention may be less than about 60° C., and is typically from about 15 to 45° C.

In terms of vapor pressures, compositions having a boiling point of less than ambient temperature (i.e., the ambient temperatures set forth above) generally also have vapor pressures that are greater than the vapor pressure of water at 14.5° C. However, the vapor pressure of the composition is not necessarily dependent upon the boiling point of the composition. The vapor pressure of the composition is typically from about 1.6 kPa at 14.5° C. (i.e., the approximate vapor pressure of water) to about 150 kPa at 14.5° C., and in some cases is from 25 to 125 kPa at 14.5° C. Compositions having such high vapor pressures create difficulties for analytical devices that employ plasmas (as described in further detail below) due to the fact that evaporation of such compositions is excessively fast and often extinguishes the plasma

In one embodiment, the composition that is analyzed in accordance with the method of the instant invention is sensitive to at least one of air and moisture. By the phrase “sensitive to at least one of air and moisture” as it is used herein, it is meant that air and/or moisture interact(s) with the composition in a manner that modifies the chemistry of the composition. For reasons to be described below, the method of analyzing of the instant invention may be particularly advantageous for compositions sensitive to air and/or moisture due to the fact that existing methods of analyzing such compositions are incapable of accurately measuring content of the impurities of the composition. One example of a composition that is sensitive to air and/or moisture comprises chlorosilane. The chlorosilane is represented by the formula SiHₐX_{b} wherein X is a halogen atom, and a is an integer from 0 to 3, and b is an integer from 1 to 4, and the sum of a and b is 4. The chlorosilane is typically present in the composition in the form of trichlorosilane, in which X is a chlorine anion, a is 1, and b is 3; however, it is to be appreciated that the chlorosilane may be present in the form of mono-, di-, tri-, and/or tetra-chlorosilane. Chlorosilanes form solid byproducts of hydrolysis (gels), thereby causing spectral interference or even plugging of the sample introduction systems in analytical devices (described below) that are typically used to analyze the compositions for content of the impurities and hindering accurate measuring of content of the impurities.

The chlorosilane is typically present in the composition in an amount of at least 99.7 percent by weight, more typically from about 99.4 to about 99.9 percent by weight, based on the total weight of chlorosilane present in the composition. Further, the trichlorosilane is typically present in the composition in an amount of at least 99.7 percent by weight, more typically from about 99.8 to about 99.9 percent by weight, based on the total weight of the composition. Accordingly, the composition including the chlorosilane typically has a boiling point in a range from −112° C. to 57.57° C., typically from about 5° C. to about 50° C., most typically about 33° C. However, in some embodiments, the composition including the chlorosilane has a boiling point of less than or equal to 10° C., e.g., when high amounts of dichlorosilane are present in the composition. In one specific embodiment, the composition comprises trichlorosilane in an amount of at least 99.9 percent by weight based on the total weight of the composition and has a boiling point of from about 32 to about 33° C.

It is to be appreciated that the composition analyzed in accordance with the method of the instant invention may include other components, in addition to or as an alternative to the chlorosilane. Typically, the composition comprises components used in the production of semiconductors. For example, in various embodiments of the instant invention, the composition that is analyzed may comprise, but is not limited to, various disilanes and various disiloxanes. The composition is typically substantially pure, i.e., the composition typically only contains chlorosilanes or one of the components listed above, typically present in an amount of at least 99 percent by weight based on the total weight of the composition.

As set forth above, the composition also contains impurities. By the term “impurities” as it is used herein, it is meant a component or components that is/are not intended to be present in the composition. The impurities typically have an adverse effect on the performance or quality of products made from the composition. While it is theoretically possible to completely eliminate all impurities from the composition, to do so would be uneconomical and many applications can tolerate a certain content of the impurities of the composition, with the tolerated content of the impurities depending upon the end use of the product made from the composition.

It is desirable to determine content of the impurities of the compositions analyzed in accordance with the instant invention at least for purposes of providing an accurate account of the composition to purchasers of the composition or to purchasers of products made from the composition. Determination of content of the impurities may also provide advantages to the method of processing the composition as described in further detail below.

The impurities measured in accordance with the method of the instant invention may be based on metals or certain non-metals. The impurities may be present in the composition in various forms of chemical species. The form of the impurities in the composition may control solubility, volatility, and other properties of the impurities contained in the composition. Notably, the presence of certain volatile impurities in the composition, and the loss of such volatile impurities during evaporation of the composition that occurs through existing testing methods, renders the method of analysis in accordance with the instant invention superior over such existing methods of analysis for reasons described in further detail below.

The impurities may be based on metals including, but not limited to, aluminum, chromium, copper, gallium, iron, nickel, lead, zinc, and combinations thereof. The metal-based impurities may be present in the composition in the form of metal oxides, metal halides, metal carbonyls, metal hydroxides, and combinations thereof. Alternatively, the impurities may be based on non-metals including, but not limited to, arsenic, boron, phosphorus, and combinations thereof. The non-metal based impurities may be present in the composition in the form of halides, oxides, or compounded with a wide variety of ligands, and in various combinations thereof.

The method of the instant invention is not limited to a particular content of the impurities of the compositions analyzed. As described in further detail below, analytical devices and techniques utilized in accordance with the method of analysis of the instant invention are capable of detecting content of the impurities on part per trillion (ppt) levels. Typically, content of the impurities is from greater than 0 to about 100 mg/L, more typically from greater than 0 to about 0.010 ng/L.

In accordance with the method of analyzing of the instant invention, the composition is provided in a liquid state within a vessel. In one embodiment, the composition is supplied in the vessel to the party performing the method of analyzing in accordance with the instant invention, with the composition in the liquid state within the vessel. Alternatively, the composition may be introduced in the liquid state into the vessel such as from a supply tank that also contains the composition in the liquid state. Because the composition has a boiling point below ambient temperature and/or a vapor pressure greater than water at 14.5° C., the composition may be under sufficient pressure within the vessel to maintain the composition in the liquid state, or the composition may be sufficiently chilled in the vessel to maintain the composition in the liquid state. Should the composition be maintained in the liquid state through high pressure, the supply tank is typically under pressure and the composition is introduced into the vessel in the liquid state while ensuring that the composition does not change from the liquid state to a gaseous state. In particular, the composition is typically provided and/or introduced into the vessel at atmospheric pressure for purposes of enabling further steps in the method of analyzing of the instant invention to be performed, which further steps are performed at ambient pressure.

It is to be appreciated that in embodiments wherein the composition is sensitive to air and/or moisture, such as for compositions including chlorosilane, the composition is typically maintained in an inert anhydrous atmosphere during the step of providing the composition to prevent air and/or moisture from hydrolyzing or otherwise reacting with the composition and compromising the results of the analysis. By “inert anhydrous atmosphere”, it is meant an atmosphere having less than 100 ppm oxygen and 0.5 weight percent moisture content. In one specific example, the composition is introduced into the vessel from the supply tank while maintaining the composition in the inert anhydrous atmosphere. For purposes of this example, the composition is introduced into the vessel through a hose or tube. The vessel into which the composition is introduced from the supply tank is typically a sealed vessel held at atmospheric pressure. The composition is introduced from this vessel into a nebulizer or other vessel from which the composition may be vaporized. Such vessels are commercially available from Hoke, Swagelok Company, or Whitey Company.

In one embodiment, at least a portion of the composition remains in the supply tank after introducing the composition into the vessel. As described in further detail below, in connection with the method of processing of the instant invention, the composition remaining in the supply tank may be further processed for purposes of making the product or products, such as semiconductors, while the composition introduced into the vessel from the supply tank is analyzed for purposes of determining content of the impurities thereof.

The composition in the liquid state within the vessel is chilled at a temperature below the boiling point of the composition, typically using a chiller. It is to be appreciated that the composition is already in the liquid state when provided in the vessel. Thus, the step of chilling the composition in the vessel functions to maintain the composition in the liquid state within the vessel. Importantly, the step of “chilling” refers to the action of the chiller on the composition, and does not necessarily mean that a temperature of the composition is lowered. For example, because the composition is already in the liquid state at commencement of the step of chilling, and because the composition has a boiling point below ambient temperature and/or a vapor pressure greater than water at 14.5° C., the natural tendency is for the temperature of the composition to rise due to the effect from the ambient temperature. Under such circumstances, the step of chilling the composition may serve to maintain the composition at a certain temperature below the boiling point of the composition and to reduce the vapor pressure of the composition. Therefore, while in some instances the action of the chiller on the composition may lower the temperature of the composition, lowering the temperature of the composition is not necessarily required.

By chilling the composition in the vessel at the temperature below the boiling point of the composition, premature vaporization and/or evaporation of the composition due to the ambient temperature is minimized. When the composition is introduced into the vessel from the supply tank, the content of the composition in the vessel is maintained substantially identical to the composition remaining in the supply tank due to chilling the composition in the vessel and maintaining the composition in the liquid state. Maintaining substantially identical content between the composition in the vessel and the composition in the supply tank is desirable for purposes of accurately determining content of the impurities of the composition in the vessel and, in turn, correlating content of the impurities of the composition in the vessel to content of the impurities of the composition remaining in the supply tank.

In one embodiment, the composition may be chilled in the vessel by chilling the vessel itself. In this embodiment, the vessel is chilled with an external chiller disposed in thermal communication with an exterior surface of the vessel. As set forth above, the vessel may be the nebulizer. In one specific embodiment, the nebulizer is a chilled concentric nebulizer, which includes a chiller jacketing the nebulizer. A suitable chilled concentric nebulizer is commercially available from Perkin-Elmer or Elemental Scientific, Inc. Alternatively, the composition may be chilled by immersing a chilling element into the composition contained within the vessel.

The method of analyzing in accordance with the instant invention further includes the step of converting the chilled composition in the vessel into at least one of a vaporized composition and a nebulized composition. As such, the step of converting the chilled composition occurs while the composition is in the liquid state, which minimizes evaporation of impurities. By “converting”, it is meant that the composition is physically converted into at least one of a vaporized composition and a nebulized composition. By “vaporized composition”, it is meant that the composition is converted into a vapor. By “nebulized composition”, it is meant that the composition is converted into a fine mist of liquid droplets. The converted composition substantially maintains the same content as the composition in the supply tank. As set forth above, the vessel may be the chilled concentric nebulizer, which by its nature is adapted to nebulize the composition contained therein. As known in the art, nebulizing is accomplished by adducting the composition into a stream of gas in the nebulizer, resulting in formation of the aerosol. Typically, the gas is an inert gas. The inert gas may be selected from the group of Noble Gases such as, for example, helium or argon; or nitrogen. Typically, the composition is converted at a rate of from about 20-500 μl/min, more typically from 50-100 μl/min.

As with the step of providing the composition in the vessel, when the composition is sensitive to at least one of air and moisture, the composition is typically maintained in an inert anhydrous atmosphere during the step of converting the composition to prevent moisture from hydrolyzing or otherwise reacting with the composition and compromising the results of the analysis.

The method of analyzing in accordance with the instant invention further includes the step of introducing the converted composition into an analytical device. The composition is typically introduced directly into the analytical device from the vaporizer or nebulizer. More specifically, the vessel is typically sealed during the step of converting the composition, with an outlet located above the composition in the vessel. The converted composition is gathered above the composition, and the converted composition is directed through the outlet and into tubing that connects the vessel to the analytical device. As such, the converted composition is typically isolated from the ambient atmosphere to prevent contamination of the vaporized composition from the ambient atmosphere, and also to prevent reaction with air or moisture. Pressure generated from the step of converting the composition in the vessel is sufficient to move the converted composition through the tubing and into the analytical device. Typically, the converted composition is introduced into the analytical device at the same rate at which the composition is converted into the vaporized composition and/or the nebulized composition.

As alluded to in the foregoing description, in embodiments in which the composition is sensitive to at least one of air and moisture, the composition is maintained in the inert anhydrous atmosphere during the step of providing the composition in the vessel through the step of introducing the converted composition into the analytical device. Because it is generally difficult to maintain sufficiently low levels of moisture in the ambient atmosphere surrounding the vessel including the composition, the composition is typically isolated from ambient atmosphere during the step of providing the composition in the vessel through the step of introducing the converted composition into the analytical device. The manner in which the vessel is isolated from the ambient atmosphere is described above.

Typically, the analytical device into which the converted composition is introduced is a spectrometer. In one specific embodiment, the analytical device is an inductively coupled plasma (ICP) spectroscopy device. Examples of techniques performed with the ICP spectroscopy device include ICP mass spectroscopy (MS), ICP optical emission spectroscopy (OES), and ICP atomic emission spectroscopy (AES), each of which are known techniques for measuring elemental content of compositions. ICP-MS is a technique employed for analyzing inorganic elements, in particular metals, and is particularly suitable for measuring content of the impurities of the compositions analyzed in accordance with the instant invention. ICP-MS offers essentially simultaneous multi-element analysis for most of the periodic table, produces simple mass spectra, exhibits excellent sensitivity and can determine elemental concentrations at the part-per-trillion (ppt) level. If the ICP-MS instrument is fitted with a dynamic reaction cell or various magnetic sector devices, elemental concentrations can be determined at the part-per-quadrillion (ppq) level.

The converted composition is typically ionized in the analytical device. More specifically, when the analytical device is the ICP spectroscopy device, the converted composition is ionized upon introduction into the analytical device. For ICP-MS techniques, the ICP spectroscopy device employs an inductively coupled plasma that utilizes an inert gas, such as argon, to generate the plasma. The plasma de-solvates, atomizes and ionizes the converted composition. The ICP spectroscopy device further includes a mass spectrometer, which is typically a quadrupole mass analyzer, that is utilized to separate and measure analyte ions formed as a result of ionization of the converted composition. The resulting ions are then transferred from the plasma, at atmospheric pressure, to the mass spectrometer. The mass spectrometer is situated inside a vacuum chamber, and the ions are transferred into the vacuum chamber via a differentially pumped interface. The ions pass through two orifices in the interface, known as sampling and skimmer cones, and are focused into the quadrupole mass analyzer. The analyzer separates the ions based on their mass/charge ratio prior to measurement by an electron multiplier detection system. Finally, a measurement of content of the impurities of the composition is obtained from the analytical device. Specifically, each elemental isotope appears at a different mass with a peak intensity directly proportional to the initial concentration of that isotope in the sample; in this manner elemental concentrations in the sample can be measured and obtained from the analytical device. Specifically, the method of analysis of the instant invention detects content of the impurities to an accuracy of +/− about 0.010 ng/L and, in some cases, can detect content of the impurities to an accuracy of +/− about 0.001 ng/L.

Unlike existing methods of analyzing compositions, especially chlorosilane compositions, in which only residues of the composition are measured to determine content of the impurities of the compositions, the method of analyzing of the instant invention eliminates the need to remove the chlorosilane from the composition prior to introducing the converted composition into the analytical device. In particular, by chilling the composition, evaporation of the composition is avoided. Further, when the composition is maintained in the inert anhydrous atmosphere during the step of introducing the composition into the vessel through the step of introducing the converted composition into the analytical device, adverse affects on the composition from air and/or moisture are avoided. It is the evaporation of the composition, especially compositions including chlorosilanes, and the adverse affects of air and/or moisture on the compositions that cause the spectral interference with the techniques performed by the ICP spectroscopy devices, or even extinguish the plasma itself. By chilling the composition and converting the chilled composition into the vaporized composition and/or the nebulized composition, and by maintaining the composition in the inert anhydrous atmosphere as necessary, the method of the instant invention provides a solution to evaporation of the composition that forced other methods of analysis to be utilized in the past that relied upon residue left after evaporation of the composition to measure content of the impurities.

The method of analysis of the instant invention has many advantages. In particular, the method may be integrated with other methods of processing the composition, as described in further detail below. Further, the method of analysis may be performed, and measurements of content of the impurities can be obtained, substantially faster than existing methods of analysis that require evaporation of the composition. In particular, the measurement of content of the impurities from the analytical device is typically obtained within a period of one hour of the step of providing the composition in the liquid state within the vessel and, under some circumstances, may be obtained within a period of a few minutes. Further still, the method of the instant invention prevents coating of components within the analytical device with the composition being analyzed. For example, coating of components within the analytical device with chlorosilane may result in malfunction of the analytical device.

The short period of time within which the measurement of content of the impurities of the compositions can be obtained from the analytical device provides many processing advantages in connection with the method of processing the composition, as described in further detail below. Further, the accuracy of content of the impurities measured in accordance with the method of the instant invention is maximized due to the fact that many volatile impurities are retained in the composition for measurement by chilling the composition.

In another embodiment of the instant invention, the method of analyzing the content of impurities of the composition utilizes a gas chromatograph. In this embodiment, the method is particularly suitable for compositions that comprise chlorosilane and having a boiling point of less than about 58° C. and a vapor pressure of from 25 kPa at 14.5° C. to 150 kPa at 14.5° C. such as the specific compositions set forth above that comprise chlorosilane. Again, the composition is provided in a liquid state within a vessel. However, instead of chilling the composition in the chilled vessel at the temperature below the boiling point of the composition, the composition is instead introduced into a gas chromatograph. To perform gas chromatography, the composition is entrained in a carrier gas and passed into the gas chromatograph. Suitable carrier gases include the Noble Gases and nitrogen, as described above. The gas chromatograph utilizes a a column through which different portions of the composition in the carrier gas pass at different rates depending on various chemical and physical properties of the chemical constituents and the interaction of the portions with a stationary phase of the column. For purposes of the instant invention, the stationary phase is typically “crossbond” triflouropropylmethyl polysiloxane available in a Restek Rtx-200 column. The function of the stationary phase in the column is to separate different portions of the composition, causing the portions to exit the column at a different time. Other parameters that can be used to alter the order or time of retention are the carrier gas flow rate and the temperature. One example of a suitable gas chromatograph that may be utilized in accordance with the instant invention is a CLARUS 600 Gas Chromatograph commercially available from Perkin-Elmer Corporation.

The chlorosilane is separated from the composition in the gas chromatograph to produce a chlorosilane portion and a residual portion. By separating the chlorosilane portion from the residual portion, the chlorosilanes in the composition are effectively removed from the composition, thus avoiding the effects that the chlorosilanes would otherwise have on measurements obtained through the ICP techniques and preventing the composition from extinguishing the plasma. The residual portion is introduced into the analytical device, which may be any of the ICP spectroscopy devices set forth above. In one specific embodiment, the residual portion may be chilled prior to the step of introducing the residual portion into the analytical device, such as in the chilled vessel described above, in order to reconcentrate the sample prior to analysis. Typically, the analytical device is an inductively coupled plasma mass spectroscopy device. A measurement of content of the impurities in the residual portion is obtained from the analytical device.

The method of processing the composition in accordance with the instant invention may include the steps in the method of analysis described in detail above. For example, the method of processing the composition may include providing the supply tank including the composition, and a portion of the composition in the supply tank may be diverted into the vessel and subjected to the method of analysis of the instant invention, with at least some of the composition remaining in the supply tank after introducing the composition into the vessel. The composition remaining in the supply tank is used to make products. In one embodiment, the composition processed in accordance with the instant invention is reacted to form the products, with content of the impurities measured in accordance with the method of analysis described above used for quality control purposes. In this embodiment, the method of processing further includes the step of introducing the portion of the composition remaining in the supply tank into a reactor. When the composition comprises chlorosilane and, in particular, trichlorosilane, the composition may be introduced into the reactor for purposes of producing polycrystalline silicon. In another embodiment, the composition may be mixed with other components to form the product, which comprises a mixture of components in the composition and the other components. For example, a second composition may be mixed with the portion of the composition remaining in the supply tank based upon the measured content of the impurities obtained from the analytical device. The second composition is typically similar to the composition analyzed, but has a different content of the impurities to produce a product having a content of the impurities that falls between the content of the impurities of the composition and the second composition. To illustrate, based on the content of the impurities of the composition as measured through the method of analysis, upon determining that content of the impurities of the composition is too high, it may be possible to mix the composition having the excessive content of the impurities with the second composition having a lower content of the impurities, thereby lowering the overall content of the impurities of the composition below an acceptable level for a given application. In this embodiment, the mixture of the composition and the other composition may be introduced into the reactor as described above. Alternatively, the mixture may be sold to customers for further processing.

The following examples are meant to illustrate the invention and are not to be viewed in any way as limiting to the scope of the invention.

### EXAMPLES

Compositions are analyzed in accordance with the method of analysis of the instant invention. Four different compositions, corresponding to Examples 1-4, were analyzed in accordance with the instant invention. The compositions include chlorosilanes, and are analyzed for purposes of determining content of impurities of the compositions. Each of the compositions has a vapor pressure greater than water at 14.5° C. and, for purposes of the analysis performed, had a vapor pressure of about 53.33 kPa at 14.5° C.

The compositions were provided in a 300 milliliter supply tank commercially available from Hoke, Swagelok Company, or Whitey Company, and the compositions were maintained in the liquid state in the supply tank by the vapor pressure of the composition inside the supply tank. 100 mL of the composition was introduced into a vessel from the supply tank. The vessel is a 150 mL chilled 3-port sealed evaporation dish. A chilled concentric nebulizer commercially available from Perkin-Elmer or Elemental Scientific, Inc converts the composition from the chilled vessel into a nebulized composition. The composition was introduced into the chilled concentric nebulizer under conditions of isolation from the ambient atmosphere. In particular, the chilled vessel is contained within an inert anhydrous isolated chamber, with a sampling tube extending from the chilled vessel into the nebulizer. Prior to introducing the composition into the nebulizer, the chiller was set to chill the vessel to a temperature of about −78.5° C. Upon introducing the composition into the nebulizer, the composition was maintained in the liquid state through action of the chiller upon the nebulizer.

The inert anhydrous isolated chamber including the chilled vessel was positioned immediately adjacent to an analytical device, which is an ICP spectroscopy device commercially available from Perkin-Elmer. The nebulized composition was introduced into the ICP spectroscopy device, where the nebulized composition was exposed to the plasma to ionize the nebulized composition. The ionized composition was then subjected to inductively-coupled plasma spectroscopy to determine to content thereof.

For comparative purposes, it would be desirable to analyze the compositions in the same manner as described above, but with the chiller in the chilled concentric nebulizer inactive for purposes of illustrating the effect of chilling the composition during nebulizing. Unfortunately this is impossible because, as mentioned above, the high vapor pressure of the samples extinguishes the plasma and renders the analysis impossible.

For comparative purposes, the compositions are analyzed in accordance with the method described in Wong et al., “Determination of Metals Impurity Concentrations in Semiconductor Gases”, 1994 IEEE/SEMI Advanced Semiconductor Conference, page 212 in the section entitled “Residue Sampling”.

The content of the impurities measured in accordance with the method of the instant invention provides more accurate results in terms of content of the impurities, and the time required to obtain the results is diminished when compared to the time required to obtain the results in the Comparative Examples.

Obviously, many modifications and variations of the present invention are possible in light of the above teachings, and the invention may be practiced otherwise than as specifically described within the scope of the appended claims.

1. A method of analyzing a composition containing impurities and having a boiling point less than ambient temperature and/or a vapor pressure greater than water at 14.5° C., said method comprising the steps of:
introducing the composition in a liquid state within a vessel;
chilling the composition in the liquid state within the vessel at a temperature below the boiling point of the composition;
converting the chilled composition in the vessel into at least one of a vaporized composition and a nebulized composition;
introducing the converted composition into an analytical device; and
obtaining a measurement of content of the impurities in the composition from the analytical device.

2. A method as set forth in claim 1 wherein the step of converting the chilled composition is further defined as nebulizing the composition in the vessel.

3. A method as set forth in claim 1 wherein the step of chilling the composition is further defined as chilling the vessel including the composition in the liquid state.

4. A method as set forth in claim 3 wherein the vessel is chilled with an external chiller disposed in thermal communication with an exterior surface of the vessel.

5. (canceled)

6. A method as set forth in claim 1 wherein the composition in the liquid state is introduced into the vessel from a supply tank containing the composition in the liquid state with at least a portion of the composition remaining in the supply tank.

7. A method as set forth in claim 1 wherein the composition is sensitive to at least one of air and moisture and wherein the composition is maintained in an inert anhydrous atmosphere during the step of providing the composition in the vessel through the step of introducing the converted composition into the analytical device.

8. A method as set forth in claim 1 wherein the composition is isolated from ambient atmosphere during the step of providing the composition in the vessel through the step of introducing the converted composition into the analytical device.

9. A method as set forth in claim 1 wherein the composition comprises chlorosilane.

10. A method as set forth in claim 9 wherein the chlorosilane is represented by the formula SiHₐX_{b} wherein X is a halogen atom, a is an integer from 0 to 3, and b is an integer from 1 to 4, and the sum of a and b is 4.

11. A method as set forth in claim 9 wherein the composition has a boiling point of less than or equal to 58° C.

12. A method as set forth in claim 11 wherein the composition has a boiling point of less than or equal to 10° C. and a vapor pressure of from 25 to 150 kPa at 14.5° C.

13. A method as set forth in claim 9 wherein the composition comprises chlorosilane in an amount of at least 99.7 percent by weight based on the total weight of the composition.

14. A method as set forth in claim 1 wherein the converted composition is ionized in an inductively coupled plasma spectroscopy device.

15. (canceled)

16. A method as set forth in claim 14 wherein the measurement of content of impurities in the composition from the inductively coupled plasma spectroscopy device is obtained within a period of 0.5 hours of the step of providing the composition in the liquid state within the vessel.

17. A method of processing a composition containing impurities and having a boiling point less than ambient temperature and/or a vapor pressure greater than water at 14.5° C. in accordance with claim 6, said method further comprising the step of introducing the portion of the composition remaining in the supply tank into a reactor.

18. A method as set forth in claim 17 wherein the composition is maintained in an inert anhydrous atmosphere during the step of providing the composition in the vessel through the step of introducing the converted composition into the analytical device.

19. A method as set forth in claim 17 further comprising the step of mixing a second composition with the portion of the composition remaining in the supply tank based upon the measured content of the impurities obtained from the analytical device.

20. A method as set forth in claim 17 wherein the composition has a boiling point of less than or equal to 10° C. and a vapor pressure of from 25 to 150 kPa at 14.5° C.

21. A method as set forth in claim 17 wherein the composition comprises chlorosilane in an amount of at least 99.7 percent by weight based on the total weight of the composition.

22. A method as set forth in claim 17 wherein the converted composition is ionized in an inductively coupled plasma spectroscopy device.

23. (canceled)

24. A method as set forth in claim 22 wherein the measurement of content of impurities in the composition from the inductively coupled plasma spectroscopy device is obtained within a period of 0.5 hours of the step of providing the composition in the liquid state within the vessel.

25.-27. (canceled)
